(19) United States
(12) Patent Application Publication
(10) Pub. No.: US 2006/0153468 A1
(43) Pub. Date: Jul. 13, 2006

(54) Imaging system and method for optimizing an x-ray image

(76) Inventors: Torsten Solf, Aachen (DE); Kai Eck, Aachen (DE)

Correspondence Address: Thomas M Lundin;Philips Intellectual Property & Standards, 595 Miner Road, Cleveland, OH, 44143, US

(21) Appl. No.: 10/526,513

(22) PCT Filed: Aug. 26, 2003
(86) PCT No.: PCT/IB03/03840

§ 371 Date: Mar. 4, 2005

(30) Foreign Application Priority Data
Sep. 4, 2002 (DE) 102 40 727.4

(51) Int. Cl. G06K 9/40

(52) U.S. Cl. 382/254

(57) ABSTRACT

The invention relates to an imaging (X-ray) system for observing the motion of an object in the vascular system of a body volume (10). An X-ray apparatus (3) in this system generates two-dimensional projection images (4) of the body volume (10). In a module (5) the position of the tip of the object is determined from the projection images and this position is associated, in a further module (2), with a previously acquired three-dimensional representation (1) of the vascular system. The module (2) then calculates optimum imaging parameters which involve notably a planar projection of the tip of the object and a minimum projection window. These parameters are subsequently set on the X-ray apparatus (3) so as to serve as a basis for the next two-dimensional image (4).

The invention relates to a method of optimizing a two-dimensional image of a body volume which contains an object, as well as to an imaging system which is arranged to carry out such a method.

Imaging methods that generate a two-dimensional image of a body volume are used in various fields of application. The generating of two-dimensional (X-ray) images of a biological body volume will be considered hereinafter by way of example; an object such as, for example, the tip of a catheter or a guide wire then moves in the blood vessels within said body volume. The invention, however, is by no means restricted to such applications and can be used in all cases with similar circumstances.

During the movement of an object through the body of a patient the object follows the course of the vessels; this often gives rise to a change of direction. An imaging system for generating a two-dimensional projection of the body volume containing the object, therefore, must be continuously readjusted in order to ensure optimum imaging of the object in the current position. In this respect “optimum” usually means a planar projection of the object or the surrounding segment of the vascular system. Such readjustment is very time-consuming for the medical staff and leads to an additional radiation burden for the patient during the readjustment.

From prior art it is known to generate and store three-dimensional representations of the vascular system of a given body volume. Representations of this kind can be acquired by means of various imaging methods such as computer tomography (CT), magnetic resonance (MR), rotation angiography (RA) or three-dimensional ultrasound (3DUS). Moreover, from U.S. Pat. No. 6,317,621 B1 it is known to combine a three-dimensional representation of the vascular system with a current two-dimensional projection image in such a manner that the current position of a catheter can be determined and associated with the three-dimensional representation. To this end, a number of markers are provided on the body of the patient; such markers are reproduced in the three-dimensional data as well as in the current projection images so that they can be associated with one another.

Considering the foregoing it was an object of the present invention to provide an imaging system and a method for the operation thereof which enable a comparatively simple optimization of the representation of a body volume with an object contained therein. Preferably, the radiation load should be minimized for the body volume.

This object is achieved by means of a method as disclosed in the characterizing part of claim 1 as well as by means of an imaging system as disclosed in the characterizing part of claim 3. Advantageous embodiments are disclosed in the dependent claims.

The method in accordance with the invention for optimizing a two-dimensional image of a (biological or non-biological) body volume containing an object is characterized in that

a) a three-dimensional representation of feasible locations of the object within the body volume is acquired, feasible locations being, for example, trajectories or channels in the body volume along which the object can move,

b) the current position of the object is determined and associated with the three-dimensional representation (this means that the data point associated with the current position of the object is identified from among the data constituting the three-dimensional representation),

c) imaging parameters are determined by means of the three-dimensional representation, which imaging parameters are optimum in respect of the current position of the object, in conformity with a predetermined optimization criterion,

d) a two-dimensional image of the body volume is generated by means of said optimum imaging parameters, which image need not necessarily cover the entire body volume and may be limited to a part of interest.

The described method utilizes the data of a three-dimensional representation of all feasible locations as well as the current location of the object so as to calculate automatically parameters for an optimum two-dimensional image and to generate a corresponding image. The two-dimensional representation of the body volume can thus be optimized for many important applications, without it being necessary for a human operator to carry out adjustments or to acquire test images. Therefore, optimized images can be acquired in an automated fashion, that is, within a substantially shorter period of time and also with a smaller radiation load for the body volume.

The two-dimensional image optimized by means of the method may in principle be any kind of image whereby a two-dimensional representation is formed from a volume. For example, it may be a sectional image formed by means of an ultrasound apparatus. The two-dimensional image, however, may in particular be a projection of the body volume which is generated by means of X-rays. This type of imaging is suitable particularly for the observation of the motion of an object through a body volume, because the image thus arising contains information from the entire volume so that the object is included in any case.

Knowledge of the current position of the object is required in order to carry out the described method. This knowledge may originate in principle from any suitable source of information, for example, from a separate imaging method, from a localization method utilizing electromagnetic field measurements (“active localizer”) or, in special applications, also from the determination of the configuration in space of an instrument carrier projecting from the body volume. Preferably, the position of the object is determined from a first two-dimensional image which has been formed by means of the same method as the optimized two-dimensional image, because only a single imaging system will be required in that case.

The nature of the imaging parameters that are optimally determined by the method is governed by the respective imaging method used. In this context notably the following imaging parameters may be involved: the sectional plane of an image, a projection direction, the position (location, orientation) of a radiation source, the position of an imaging radiation detector, the shape (including the size) of an imaging window, the position of radiation-attenuating diaphragm elements, variances in the radiation field across an irradiated surface, the radiation quality (for example, adjustable by means of filters), the radiation intensity, the electrical current and/or the electrical voltage for operating a radiation source and/or the exposure time.

An important field of application of the method is the use of an imaging system in the field of medical diagnostics and therapy. The feasible locations of the object may then notably be blood vessels within a biological body volume, the optimum image parameters in that case being defined in such a manner that the local vascular segment in which the object is situated at the relevant instant is projected in the two-dimensional image in an essentially planar fashion; this means that it is projected from a direction perpendicular to the axis of the vascular segment onto a plane parallel to the axis of the vascular segment. In the context of a medical application the object may notably be a catheter, or the tip thereof, a guide wire or the like. The three-dimensional representation of the vascular system can be acquired notably by means of CT, MR, RA and/or 3DUS.

The two-dimensional image of the body volume can be advantageously displayed so as to be superposed on an image of the three-dimensional representation which has been acquired at least partly with the same imaging parameters. For example, when the two-dimensional image is a projection of the body volume, a projection with the same projection geometry can be calculated from the three-dimensional representation so as to be used for the superposition. The information contained in the three-dimensional representation is thus additionally made available to the user. It is very advantageous when the image calculated from the three-dimensional representation reproduces an area which is larger than the two-dimensional image. The “live” two-dimensional image of the current position of the object can thus be limited to a minimum size while minimizing the radiation load, because the user can extract information for the orientation in the further vicinity of the object from the superposed image derived from the three-dimensional representation.

The invention also relates to an imaging system for generating a two-dimensional image of a body volume which contains an object, which system comprises a data processing unit for image processing and control which includes a memory which stores a three-dimensional representation of feasible locations of the object within the body volume. The data processing unit is also arranged to determine imaging parameters which have been optimized in respect of the current position of the object in conformity with a given optimization criterion from the three-dimensional representation stored in the memory. Furthermore, the data processing unit is arranged to control the imaging system in such a manner that it generates a two-dimensional image with the previously mentioned optimized imaging parameters.

An imaging system of this kind offers the advantage that it utilizes a three-dimensional representation of the body volume and a correspondingly configured data processing unit for the automatic calculation of optimum imaging parameters for the relevant position of the object so as to generate a corresponding two-dimensional image. The user of the imaging system, therefore, need not carry out these operations and the formation of test images, giving rise to a radiation load, can be dispensed with.

The imaging system is preferably an X-ray apparatus which comprises an X-ray source and a detector, both of which are attached to a movable C-shaped arm. X-ray apparatus of this kind are used notably in the medical field where the combined movability of the X-ray source and the detector on the C-arm enables the formation of x-ray images from different projection directions.

The above X-ray apparatus preferably comprises diaphragms which can be adjusted by means of actuators or motors and which define the radiation cone and hence the volume covered thereby, the adjustment of such diaphragms is among the imaging parameters optimized by the data processing unit. The volume represented in the X-ray image can then be limited to a minimum as required for the representation, thus minimizing the radiation load.

In conformity with a further embodiment of the imaging system, the data processing unit is coupled to signal leads, for example, leads for an electrocardiogram (ECG) and/or a respiration sensor. The calculations to be executed by the data processing unit can be further specified by taking into account further sensor information. For example, the changing of the shape of the body of a patient which is associated with the heartbeat or the respiration can be taken into account when the position of the object is determined and associated with the three-dimensional representation. Furthermore, there may be provided a signal lead for the connection of a localization device which serves to determine the current position of the object. The localization device may be supported, for example, by a separate imaging method, by a localization method by means of electromagnetic field measurements (“active localizer”), or in special applications also by the determination of the spatial configuration of an instrument carrier projecting from the body volume.

The imaging system can notably be configured or extended in such a manner that it is capable of carrying out a method of the kind set forth.

Thus, the imaging system may be arranged, for example, to determine the position of the object from a first two-dimensional image which has been generated by means of the same method as the optimized two-dimensional image, because in this case only a single imaging system is required.

The nature of the imaging parameters optimally determined by the imaging system is dependent on the imaging methods used. Examples in this respect have already been given above.

The feasible locations of the object can notably be vessels within a biological body volume, the data processing unit in that case preferably being arranged to define the optimum imaging parameters in such a manner that the vascular segment in which the object is situated is projected essentially in a planar fashion in the two-dimensional image.

In conformity with a further version of the imaging system, it may include a device (monitor, printer, etc.) for the reproduction of images and be arranged in such a manner that the two-dimensional image is displayed so as to be superposed on an image formed from the three-dimensional representation with entirely or partly the same imaging parameters, the image formed from the three-dimensional representation preferably reproducing a larger area than the two-dimensional image. The advantages of such a common display have already been mentioned.

The invention will be described in detail hereinafter, by way of example, with reference to the Figures. Therein:

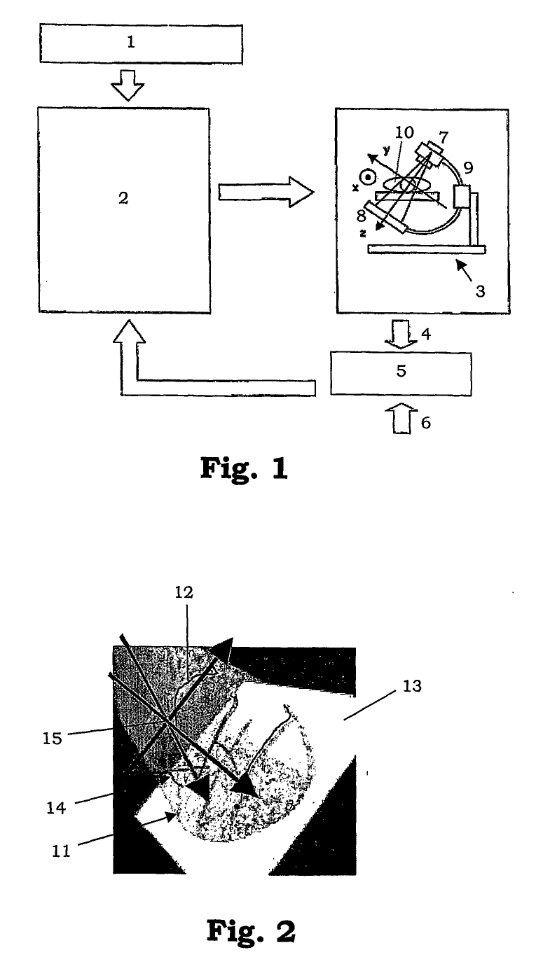

FIG. 1 shows a diagram of the imaging system in accordance with the invention, and

FIG. 2 illustrates the X-ray projection of a body volume with a vascular system and a catheter introduced therein.

FIG. 1 shows an example of the application of the invention in the form of an imaging system which is used to track the movement of the tip of a catheter through the vascular system of a patient 10. In the context of cardiological interventions, the catheter may be, for example, a catheter for a PTCA (Percutaneous Transluminal Coronary Angioplasty), a perfusion an electrophysiology (EP) mapping or an ablation.

A two-dimensional image of the body volume of interest is formed in known manner by means of an X-ray apparatus 3 which comprises an X-ray source 7 and an X-ray detector 8 which are attached to oppositely situated ends of a C-arm 9. The C-arm 9 can be pivoted in such a manner that the X-ray apparatus acquires two-dimensional images of the body volume 10 of interest from different projection directions. The images are available as “live” (real-time) fluoroscopic images 4 during the medical intervention.

A suitably programmed data processing unit in the module 5 calculates the position of the tip of the catheter within the body of the patient from the two-dimensional images 4. To this end, the module 5 receives information as regards the position of the X-ray tube 7 and the detector 8 relative to the patient 10. Preferably, the module 5 also takes into account signals from sensors 6, for example, an ECG or signals from a respiration sensor in order to enhance the precision of the determination of the position. Alternatively, the current position of the tip of the catheter can also be determined by means of other methods such as, for example, by means of ultrasound imaging or by means of an active localizer which determines its position in space relative to a magnetic field.

The position of the tip of the catheter thus determined is subsequently applied to another data processing unit or to another programming module 2 within the same data processing unit, said module 2 additionally having access to a stored three-dimensional representation 1 of the vascular tree within the body volume of interest. The data of this three-dimensional representation, vectorally and/or point-wise describing the course of the vessels in a three-dimensional co-ordinate system, has been acquired by means of a three-dimensional imaging method (for example, CT, MR, CRA, 3DUS, etc.) prior to the current intervention. The three-dimensional representation can be acquired notably by means of rotation angiography while utilizing the X-ray apparatus 3 which is also used during the current intervention.

The module 2 associates the (two-dimensional) position of the tip of the catheter as provided by the module 5 with the corresponding (three-dimensional) position of the tip of the catheter within the vascular tree. Methods of associating corresponding points in different representations of the same volume in this manner are known (for example, from U.S. Pat. No. 6,317,621 B1) and hence will not be elaborated herein. This association utilizes the fact that the catheter moves through the vascular system and that hence its tip must be situated in the vascular tree described by the three-dimensional representation.

After the determination of the position of the tip of the catheter in the vascular tree, the module 2 determines new imaging parameters which have been optimized in conformity with given optimization criteria. Optimization of this kind is obtained for the system shown in FIG. 1, that is, notably when the tip of the catheter is projected in a planar fashion, that is, from a direction extending perpendicularly to the local vascular segment in which the tip of the catheter is currently situated. In as far as there more of such directions (there are generally two 180° offset directions), preferably the direction is chosen which necessitates the least changes of settings of the X-ray apparatus. The planar projection of said vascular segment offers the advantage that it reproduces this segment with a maximum length, so that the further advancement of the tip of the catheter can be observed with the highest resolution.

Furthermore, the module 2 can calculate those boundaries of the X-ray cone that still lead to adequate imaging of the tip of the catheter of interest. These boundaries can be defined, for example, in such a manner that the resultant two-dimensional projection has the shape of an elongate rectangle in which the tip of the catheter is situated near a short side and the associated vascular segment, being adjacent in the direction of propagation, extends to the oppositely situated short side of the rectangle. Such a representation would actually be limited to the anticipated future path of motion of the catheter.

After the determination of the projection direction and the projection cone as well as possibly further imaging properties, for example, the radiation intensity of the X-ray source 7, said variables are applied to the X-ray apparatus 3 in which the corresponding settings are realized. This means that in particular the C-arm 9 is rotated until the X-ray source 7 and the detector 8 are situated in the predetermined projection direction, and that X-ray attenuating diaphragm wedges and/or X-ray transparent diaphragms are motor-driven to the position in which the imaging window determined is obtained. Subsequently, a new, optimized X-ray image can be generated.

Not being shown in detail in FIG. 1, the three-dimensional representation 1 of the vascular system and the fluoroscopic real-time images 4 from the same optimum projection angle determined can be displayed in superposed form so as to provide the user with additional information. Preferably, the projection of the three-dimensional representation 1 covers a larger area than the real-time images 4, so that the physician can look around in a comparatively large area around the object while at the same time the fluoroscopic images acquired while exposing the object to a radiation load can be limited to an as small as possible area.

The described imaging system and the associated imaging method eliminates the time-consuming re-positioning of the X-ray apparatus during complex medical interventions by utilizing an intelligent navigation control system. The medical staff no longer has to carry out the re-positioning of the C-arm 9, so that not in the least the X-ray dose whereto the patient is exposed is reduced. This dose is additionally reduced in that the image is automatically limited to the required imaging window.

FIG. 2 shows the images on which the method in accordance with the invention is based. The Fig. shows the vascular tree 14 which has been measured in advance and documented in a three-dimensional representation, and also the front segment of a catheter 12 with the catheter tip 15 inserted therein. Also shown is the X-ray cone 1 which produces a two-dimensional projection image 13 in the plane of the X-ray detector 8 (FIG. 1) (corresponding to the fluoroscopic images 4 of FIG. 1).

After the determination of the position of the tip of the catheter 15 in the three-dimensional vascular tree 14 by means of the module 2 of FIG. 1, the projection direction produces an optimum image of the catheter 12 and the tip of the catheter 15 can be determined while taking into account the course of the vessels. As is shown in FIG. 2, this may notably be a projection from a direction perpendicular to the longitudinal direction of the catheter 12 or of the surrounding segment of the vascular tree.

Even though the invention has been described in conjunction with the displacement of an instrument through the vascular system of a patient, it is by no means restricted to this application. In the biological/medical field, for example, the motion of a natural object through the body could also be observed, for example, the motion of a blood clot through the vascular system or the transport of a substance or excitation potential along other paths such as, for example, nerve tracts.

Furthermore, the invention can also be used, for example, in tool engineering applications. For example, the object could be the hand of a (multi-jointed) robot arm which is to be moved under the control of feedback signals from a video camera so as to perform a task on a spatially complex object. Using the method in accordance with the invention, in such a case an optimum position of the video camera could be adjusted, notably a position which first of all offers an unobstructed view of the hand of the robot and secondly images the hand with the highest resolution, that is, for example, in a planar fashion.

1. A method of optimizing a two-dimensional image of a body volume which contains an object, in which method
a) a three-dimensional representation of feasible locations of the object within the body volume is acquired;
b) the current position of the object is determined and associated with the three-dimensional representation;
c) imaging parameters which are optimum in respect of the position of the object are determined by means of the three-dimensional representation, and
d) a two-dimensional image of the body volume is generated by means of said optimum imaging parameters.

2. A method as claimed in claim 1, wherein the two-dimensional image is a projection of the body volume which has been generated by means of X-rays.

3. An imaging system for forming a two-dimensional image of a body volume which contains an object, which system comprises a data processing unit with a memory which stores a three-dimensional representation of feasible locations of the object within the body volume, the data processing unit being arranged
a) to determine imaging parameters which are optimum in respect of the current position of the object by means of the three-dimensional representation;
b) to control the imaging system in such a manner that it generates a two-dimensional image with said imaging parameters.

4. An imaging system as claimed in claim 3, wherein it includes an X-ray apparatus with an X-ray source and a detector which are attached to a movable C-arm.

5. An imaging system as claimed in claim 4, wherein the X-ray apparatus includes adjustable diaphragms whose adjustment forms part of the imaging parameters optimized by the data processing unit.

6. An imaging system as claimed in claim 3, wherein the data processing unit is coupled to signal leads, notably for an ECG, of a respiration sensor and/or of a localizing device for the object.

7. An imaging system as claimed in claim 3, wherein it is arranged to determine the current position of the object from a two-dimensional image.

8. An imaging system as claimed in claim 3, wherein the imaging parameters define a sectional plane, a projection direction, the position of a radiation source, the position of an imaging radiation detector, the shape of an imaging window, the position of radiation-attenuating diaphragm elements, variances in the radiation field across an irradiated surface, a radiation quality, a radiation intensity, the current and/or the voltage of a radiation source and/or an exposure time.

9. An imaging system as claimed in claim 3, wherein the feasible locations of the object are vessels within a biological body volume, and that the data processing unit is arranged to define the optimum imaging parameters in such a manner that the segment of the vascular tree in which the object is situated is projected essentially in a planar fashion in the two-dimensional image.

10. An imaging system as claimed in claim 3, wherein it includes a device for the formation of images and is arranged to display the two-dimensional image in superposed form together with an image formed from the three-dimensional representation with completely the same or partly the same imaging parameters, the image formed from the three-dimensional representation preferably reproducing an area which is larger than that reproduced by the two-dimensional image.
